(19) United States
(12) Patent Application Publication
(10) Pub. No.: US 2024/0123963 A1
(43) Pub. Date: Apr. 18, 2024

(54) Electrohydraulic Braking Method for Mobile Working Machines and a Brake Function Arrangement

(71) Applicant: Robert Bosch GmbH, Stuttgart (DE)

(72) Inventors: Jochen Mayer, Giengen An Der Brenz (DE); Patrick Glasbrenner, Venisseux (FR)

(21) Appl. No.: 18/484,681

(22) Filed: Oct. 11, 2023

(30) Foreign Application Priority Data
Oct. 18, 2022 (DE) 10 2022 210 981.3

(51) Int. Cl. B60T 13/68; B60T 8/40

(52) U.S. Cl. CPC B60T 13/686; B60T 8/4086; B60T 2260/02

(57) ABSTRACT

An electrohydraulic braking method for mobile working machines, in particular agricultural machines, is disclosed. The method is designed to detect external signals and to transmit them to a control unit, in which the signals are processed and based on which at least one target braking pressure is determined. In a next step, a valve flow is calculated on the basis of the target brake pressures, which valve flow is transmitted to a control valve of a brake actuation pedal, resulting in a braking pressure in a hydraulic circuit of the agricultural machine and the adjustment of brake steering. The disclosure further relates to a brake function arrangement designed to perform the electrohydraulic braking method.

This application claims priority under 35 U.S.C. § 119 to patent application no. DE 10 2022 210 981.3, filed on Oct. 18, 2022 in Germany, the disclosure of which is incorporated herein by reference in its entirety.

The present disclosure relates to an electrohydraulic braking method for mobile working machines, in particular agricultural machines, and to a brake function arrangement for such mobile working machines.

### BACKGROUND

Agricultural machines usually comprise a mechanically split brake pedal, which can be decoupled so that special field operation is possible. During this field operation, it is ensured that asymmetric braking, by operating the left or right pedal part, provides improved cornering as well as improved straight-ahead driving with an asymmetric load acting on the agricultural machine. In order to put the tractor into special field operation, the driver must decouple the brake pedal by means of a switch, so that a targeted one-sided braking action can take place. However, the disadvantage thereby is that the driver has to deliberately brake left or right manually.

US2020/0047738 A1 describes a system and method for brake-assisted steering of a work vehicle. Brake-assisted steering is in this case performed by determining a wheel speed and other parameters so that a speed difference is adjusted.

Other brake systems that can assist steering are known from DE199 31 865 A1, DE 10 2016 212 772 A1, US 2013/038 118 A1, and EP 3 028 908 A1.

The object of the present disclosure is to provide a braking method which enables automatic actuation of the field operation as well as providing easier handling thereby.

The object of the present disclosure is achieved by an electrohydraulic braking method as set forth below and a brake function arrangement also as set forth below.

### SUMMARY

The electrohydraulic braking method according to the disclosure for mobile working machines, in particular agricultural machines or tractors, begins with detecting at least one external signal and transmitting it to a control unit. In the control unit, the at least one detected external signal is processed, e.g. by filtering, fusing or converting it, so that at least one target braking pressure is determined and a valve flow is calculated from it. The calculated valve flow is used to control a control valve and is transmitted to the control valve of a brake actuation pedal in a further step. The control valve of the brake actuation pedal then adjusts a braking pressure in a hydraulic brake circuit, in which what is referred to as brake steering is adjusted.

According to the disclosure, the detection of the at least one external signal is performed manually via a man-machine interface or automatically via a steering angle sensor mounted on the steering train of the working machine of a tractor.

Preferably, the control unit can communicate with the steering angle sensor via a wired or wireless connection so that measurement signals can be transmitted from the steering angle sensor to the control unit.

Further preferably, the control unit can then be configured to monitor the steering angle of the work vehicle as the vehicle travels across the field based on the measurement signals received from the steering angle sensor.

Preferably, the calculation of the valve flow required to actuate the control valve is performed with the aid of characteristic diagrams, lookup tables, a suitable mathematical formula and/or algorithms that relate the measurement signals to the steering angle of the working vehicle. If the monitored steering angle exceeds a steering angle threshold, then the control unit can be configured to determine that the work vehicle is being turned or should be turned. In order to determine whether the work vehicle is actually turned over, a threshold value for a time duration can be included as a supplement. The steering angle threshold can be selected so that the control unit cannot determine that the work vehicle is turning based on minor steering inputs that are generally not indicative of turning.

Automatic brake steering is therefore achieved by the steering angle sensor continuously monitoring the steering angle during travel by the working machine. As soon as a threshold value of the steering angle is exceeded, the control unit detects not only that this threshold value has been exceeded, but also in which direction the vehicle was steered. The control unit then sends a valve flow to the control valve of the brake actuation pedal depending on the direction of the steering angle, so that a first or a second hydraulic brake circuit is pressurized with braking pressure, whereupon the brake steering comes into effect. As soon as the control unit detects that the steering angle has again fallen below the threshold value, a signal is sent to the control valve of the brake actuation pedal and the hydraulic circuit to which braking pressure is applied is released again, so that symmetrical operation of both brake circuits is activated.

Furthermore, a brake function arrangement according to the disclosure is disclosed, which is intended and designed for mobile working machines, in particular agricultural machines/tractors. In this case, the brake function arrangement comprises a hydraulic brake actuation pedal with a control valve arranged thereon for adjusting a braking pressure. Furthermore, the brake function arrangement comprises a hydraulic circuit, which is divided into a first hydraulic circuit and a second hydraulic circuit. The first hydraulic circuit drives the chain or wheel or wheels of the left side of the working machine and the second hydraulic circuit drives the chain or wheel or wheels of the right side of the working machine. Further, the first hydraulic circuit is connected to a first actuating portion of the brake actuating pedal, wherein the second hydraulic circuit is connected to a second actuating portion of the brake actuating pedal. An electronic control unit is arranged on the control valve in order to be able to transmit a calculated valve flow to the hydraulic brake actuation pedal. Furthermore, the brake function arrangement comprises a man-machine interface, which is coupled to the electronic control unit and can be operated manually by the driver. Furthermore, the brake function arrangement comprises at least one sensor which is designed to detect at least one external signal of the driven working machine.

According to the disclosure, the brake function arrangement is designed to perform the electrohydraulic braking method described hereinabove.

Preferably, the human-machine interface is designed as an external control device, which can take the form of a display, switch, button, or joystick. Alternative designs for manual actuation could also be implemented.

Preferably, the sensor is designed as a steering angle sensor and is arranged on the steering gear of the driven working machine so that the steering angle of the driven working machine can be determined.

Preferably, the hydraulic brake actuator pedal comprises first and second subassemblies configured to be assembled together in a pre-assembled manner. The first subassembly comprises the first control piston and a first actuating piston, each movable along a first axis, at least one first spring being arranged between the first control piston and the first actuating piston along the first axis. The first subassembly further comprises the second control piston and a second actuating piston, which are both movable along a second axis, at least one second spring being arranged between the second control piston and the second actuating piston along the second axis, and the first and second axes being parallel to each other. The second subassembly comprises third and fourth actuating pistons. The third actuating piston is movable along the first axis and comprises a third contact surface capable of contacting a first contact surface of the first actuating piston. The fourth actuating piston is movable along the second axis and comprises a fourth contact surface capable of contacting a second contact surface of the second actuating piston.

Preferably, the first and second assemblies are fully pre-assembled prior to installation. Preferably, at least one actuating means is provided which acts on the third and/or the fourth actuating piston to apply the brake. Preferably, the first and second actuating pistons are actuated only by the third or fourth actuating pistons. Further, the first through fourth contact surfaces are flat and oriented perpendicular to the first or second axis. Preferably, an outer diameter of the first actuating piston at the first contact surface is larger than an outer diameter of the first control piston. Preferably, an outer diameter of the second actuating piston is larger than an outer diameter of the second control piston. Preferably, the first and/or the second control piston are part of a pressure reducing valve.

It can be provided that the second subassembly comprises a second body that receives the third and fourth actuating pistons, the second body being attached to a first body of the first subassembly, and the first body accommodating the first and second coils, the first and second actuating pistons, and the at least one first spring and the at least one second spring. The diameter of the third actuating piston at the third contact surface is smaller than a diameter of the first actuating piston at the first contact surface. The second body limits a movement of the first actuating piston along the first axis and/or a diameter of the fourth actuating piston at the fourth contact surface is smaller than a diameter of the second actuating piston at the second contact surface, wherein the second body limits a movement of the second actuating piston along the second axis. In this embodiment, the diameter of the first and fourth actuating pistons can be flexibly adapted to the selected type of actuation. The first and second actuating pistons are identical for all types of actuation.

Preferably, the first and second bodies adjoin on a planar surface that is perpendicular to the first and second axes. Preferably, the first and second bodies and the first and second slides define an outlet chamber fluidly connected to an outlet connection of the first body. The pressure in the exhaust chamber preferably acts on the first and second pressure in the exhaust chamber preferably acts on the first and second actuating pistons equally from all sides, so as to produce no net force on the first or second actuating pistons, or the second actuating pistons.

It can be provided that the third actuating piston together with the second body delimits a first chamber, whereby the volume of the first chamber increases when the third actuating piston is moved in the direction of the first control piston and/or whereby the fourth actuating piston together with the second body delimits a second chamber, the volume of the second chamber increasing when the fourth actuating piston is moved in the direction of the second control piston. The second assembly comprises at least one control valve fluidly connected to the first and/or second chambers. In this embodiment, electromechanical actuation of the brakes is provided. It should be noted that the corresponding control pressure does not act directly on the first or second control piston. Instead, the corresponding action takes place via the at least one first or second spring. Doing so enables better fine control of the braking force and avoids oscillations of the braking force. Preferably, the at least one control valve is a pressure reducing valve having an outlet pressure connected to the first and/or second chamber. Preferably, an adjustment pressure of the control valve is adjusted electrically. If a control valve is provided, then this control valve is preferably fluidically connected in parallel with the first and second chambers so that the first and second chambers have the same pressure. If two control valves are provided, then the first and second chambers are preferably fluidically connected by a separate control valve each. Using this embodiment, it is possible to have an electromechanically actuated hydraulic brake actuation pedal, although a mechanical means of directly actuating the sliders may or may not be provided.

It can be provided that the first and second control pistons each have a separate pressure source, wherein the at least one control valve is connected to said at least one pressure source for pressure supply. Preferably, a shuttle valve is provided, in which case the pressure sources are connected to an input side of the shuttle valve, an output side of the shuttle valve being connected to the at least one control valve. The shuttle valve is preferably arranged in the second subassembly. Each pressure source comprises a hydraulic accumulator. If two control valves are provided, then each control valve can be connected to a separate pressure source.

It can be provided that the hydraulic brake actuating pedal comprises a movable actuating element configured to actuate the first and second control pistons in parallel, there being a third subassembly configured to be pre-assembled to the second subassembly, the third subassembly comprising the actuating element. The actuating element is configured to contact the third and fourth actuating pistons in parallel. In this embodiment, purely mechanical actuation of the brakes is provided. Preferably, the actuating element is a pedal that can be actuated by a human foot. It is also possible to use an actuating element designed for actuation by a human hand. Said contact between the actuating element and the third and/or fourth actuating pistons can be omitted when the actuating element is not actuated.

It can be provided that the third assembly comprises a third body attached to the second body, the actuating element being movably supported on the third body, the remaining actuating element having a rocker pivotally supported with respect to a third axis, the rocker comprises one first and one second free end, which ends are located on opposite sides of the third axis, the first free end being capable of contacting the first actuating portion and the second free end being capable of contacting the second actuating portion. In this embodiment, the force of the actuating element can be distributed evenly between the first and second coils. If one of the coils blocks due to a fault, then the other coil remains functional. Preferably, the second and third bodies adjoin on a planar surface that is perpendicular to the first and second axes.

It can be provided that the actuating element is a pedal pivotally mounted to the third body with respect to a fourth axis, the fourth axis being perpendicular to the first and second axes and the distance from the fourth to the first axis and from the fourth to the second axis being equal. Preferably, a sensor is provided that is designed to measure the pivot angle of the pedal with respect to the fourth axis. Preferably, the sensor makes use of the reverb effect. Preferably, the third axis is perpendicular to the fourth axis, being arranged between the first and second axes.

### BRIEF DESCRIPTION OF THE DRAWINGS

FIG. 1 is a diagram illustrating an electrohydraulic braking process according to the disclosure in interaction with a brake function arrangement according to the disclosure.

FIG. 2 shows a sectional view of a hydraulic brake actuating pedal known from EP 3 944 996 A1.

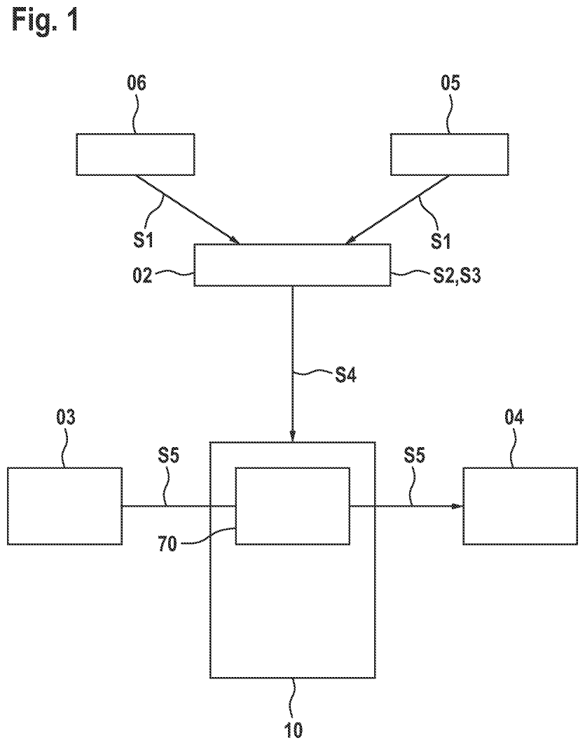

In a first step S1 shown in FIG. 1, external signals are detected by a sensor 06 and/or a man-machine interface 05 (both of which are connected to a control unit 02) and transmitted to the control unit 02. The sensor 06 can in this case be designed as a steering angle sensor and be arranged on the steering train of a mobile working vehicle, whereby the man-machine interface 05 can be designed as a display, head, switch or joystick, which is arranged within the mobile working vehicle.

The detection of the steering angle signals as external signals can in this case be performed automatically and continuously, whereby the external signals are manually performed by the man-machine interface 05, in that the driver of the mobile working vehicle manually performs the adjustment of brake steering via the man-machine interface 05.

In the following step, the external signals are processed by processors in the control unit 02, for example, which are not shown, and a target braking pressure S2 is determined. Processing of external signals can be the filtering, merging, or smoothing of signals. Based on the target braking pressure, a valve pressure flow is calculated S3 in a third step, which is then transmitted S4 to a control valve 70 connected to the control unit 02, the control valve 70 being arranged on a brake actuating pedal 10 and designed to adjust a braking pressure via the brake actuating pedal 10.

In a final step, the control valve 70 receives the electric valve flow detected by the control unit 02 and sets a braking pressure in one of the two braking circuits 03, 04 arranged on the control valve 70. The steering angle sensor 06 can thereby determine in which direction the driver is steering, so that the control valve 70 brakes and/or blocks the brake circuit via the control unit 02 and the brake actuating pedal 10 so that the desired steering direction is adjusted.

Automatic brake steering is therefore performed by the steering angle sensor 06 continuously monitoring the steering angle during travel by the working machine. As soon as a threshold value of the steering angle is exceeded, the control unit 06 detects not only that this threshold value has been exceeded, but also in which direction the vehicle was steered. The control unit 06 then sends the valve flow to the control valve 70 of the brake actuating pedal 10 depending on the direction of the steering angle so that its control valve 70 blocks a first or a second hydraulic circuit 03, 04, whereupon the brake steering comes into effect.

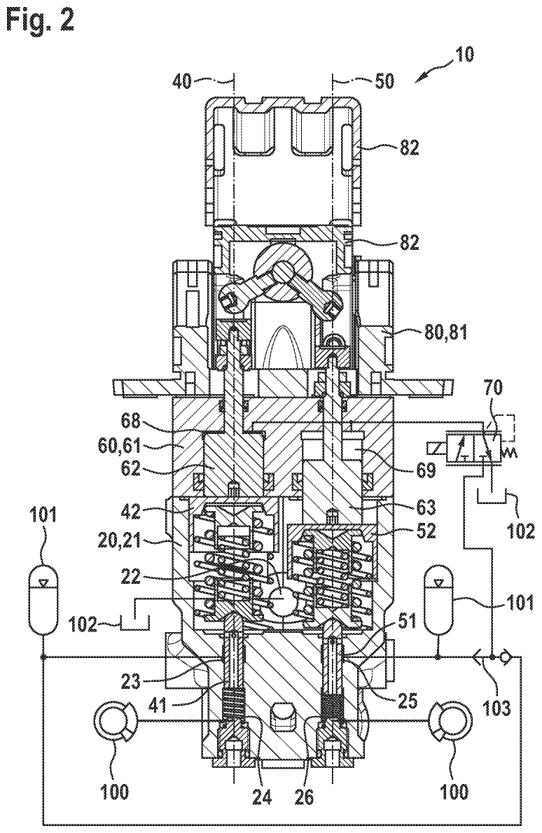

As soon as the control unit 02 detects that the steering angle has again fallen below the threshold value, a signal is sent via the control valve 70 to the brake actuating pedal 10 and the blocked hydraulic circuit 03, 04 is released again so that symmetrical operation of both brake circuits 03, 04 is activated. The mechanical implementation of the braking process using the brake actuating pedal 10 is shown in FIG. 2 and described in the following paragraphs.

FIG. 2 shows a sectional view of a hydraulic brake actuating pedal 10 which is known from EP 3 944 996 A1. The hydraulic brake actuating pedal 10 comprises first, second, and third subassemblies 20; 60; 80. Each subassembly 20; 60; 80 can be completely pre-assembled. The entire hydraulic brake actuating pedal 10 is then assembled from the aforementioned three assemblies 20; 60; 80. Said assemblies 20; 60; 80 are preferably connected to each other via screw connections. In particular, the third assembly 60 exists in different variants, with FIG. 2 showing one of the more sophisticated variants of the second assembly 60, which enables purely manual operation of the brakes 100 and electrohydraulic operation via the first control valve 70. According to EP 3 944 996 A1, two separate control valves can be provided. In order to achieve different operating variants, the second assembly 60 in particular must be modified. The first and third subassemblies 20; 80 can be left unchanged. The first and third assemblies can as a result be manufactured in high volume and at low cost.

The first subassembly 20 comprises first and second braking pressure connections 24; 26, each connected to a respective brake 100. The brake 100 can be a disc brake or a drum brake. Multiple brakes can be connected in parallel to each braking pressure connection 24; 26. Both brakes 100 are actuating in parallel by an actuating element 82 to have two independent brake circuits and to increase safety. This embodiment of the disclosure provides a purely mechanical coupling between the actuating element 82 and the first and second control pistons 41; 51 when the third assembly 80 is provided. The brake system can then be operated safely even if the electrohydraulic actuation fails. The actuating element 82 is part of the third subassembly 80.

The first assembly 20 further comprises first and second supply connections 23; 25. These are typically each connected to one of two independent pressure sources 101 to increase safety. The pressure sources 101 preferably each comprise a hydraulic accumulator. Preferably, a system for filling the accumulators is provided, which is not shown in FIG. 1.

The first subassembly 20 comprises a vent connection 22 connected to a tank 102. The hydraulic brake actuating pedal 10 is preferably operated with hydraulic oil rather than the DOT brake fluid used in motor vehicles. The hydraulic brake actuating pedal 10 is preferably used in vehicles that have hydraulic work functions and/or a hydraulic traction drive, where all hydraulic functions including the brake use a common pump to supply hydraulic pressure.

The first and second sliders 41; 51 are movable along first or second axes 40; 50, the first and second axes 40; 50 being a central axis of the corresponding first or second slider 41; 51. The first and second axes 40; 50 are parallel to each other. The first subassembly 20 comprises a first body 21 that adjoins a second body 61 of the second subassembly 60 with a flat surface that is perpendicular to the first and second axes 40; 50. The second body 61 limits the movement of the first or second actuating piston 42; 52 by means of said planar surface. The third subassembly 80 comprises a third body 81, a planar surface of which that is perpendicular to the first and second axes 40; 50 adjoins the second body 61.

FIG. 1 shows the first control valve 70 in a symbolic manner, wherein the first control valve 70 is part of the second subassembly 20 in the shown embodiment. The first control valve 70 is designed as a pressure reducing valve that is electrically operated, i.e., the output pressure of the first control valve 70 is proportional or inversely proportional to the current that controls the first control valve 70. The accumulators of the two independent pressure sources 101 are preferably each connected to an input side of the shuttle valve 103, the corresponding output side being connected to a supply connection of the first control valve 70. The exhaust connection of the first control valve 70 is connected to the tank 102.

In the embodiment shown in FIG. 2, the first and second chambers 68; 69 of the second subassembly 60 are connected in parallel to the first control valve 70 so that both chambers 68; 69 have the same pressure. It is possible to provide a separate control valve for each of the first or second chambers 68 or 69.

### LIST OF REFERENCE SIGNS

02 Control unit
03 First hydraulic brake circuit
04 Second hydraulic brake circuit
05 Human-machine interface
06 Steering angle sensor
10 Hydraulic brake actuating pedals
20 First subassembly
21 First body
22 Exhaust gas connection
23 First supply connection
24 First braking pressure connection
25 Second supply connection
26 Second braking pressure connection
40 First axis
41 First control piston
42 First actuating piston
50 Second axis
51 Second control piston
52 Second actuating piston
60 Second subassembly
61 Second body
62 Third actuating piston
68 First compartment
69 Second compartment
70 First control valve
80 Third subassembly
81 Third housing
82 Actuating element
100 Brake
101 Pressure source
102 Container/tank
103 Shuttle valve

What is claimed is:

1. An electrohydraulic braking method for a mobile working machine, comprising:
detecting at least one external signal and transmitting it to a control unit;
processing the at least one external signal and determining at least one target braking pressure based on the at least one external signal;
calculating a required valve flow based on the at least one target braking pressure determined;
transmitting the calculated valve flow to a control valve of a brake actuating pedal; and
adjusting a braking pressure in a hydraulic brake circuit via the brake actuating pedal so that brake steering is adjusted,
wherein the detection of the at least one external signal is performed manually via a man-machine interface or automatically via a steering angle sensor.

2. The electrohydraulic braking method according to claim 1, wherein the transmission of the at least one external signal detected by the steering angle sensor, which is designed as a digital or analog electronic signal, to the control unit takes place via a wired or wireless connection.

3. The electrohydraulic braking method according to claim 1, wherein:
during travel by the mobile working machine, the steering angle sensor continuously monitors the steering angle of the mobile working machine.

4. The electrohydraulic braking method according to claim 1, wherein the calculation of the necessary valve flow is performed with the aid of mathematical formulas, and/or algorithms, and/or a predetermined threshold value.

5. A brake function arrangement for a mobile working machine, comprising:
a hydraulic brake actuating pedal configured to adjust a braking pressure;
a control valve arranged on the hydraulic brake actuating pedal;
a hydraulic circuit divided into one first hydraulic circuit and one second hydraulic circuit, wherein the first hydraulic circuit is arranged and operatively connected to a first actuating portion of the brake actuating pedal, and the second hydraulic circuit is arranged and operatively connected to a second actuating portion of the brake actuating pedal;
an electronic control unit connected to the control valve and configured to transmit a calculated valve flow to the hydraulic brake actuating pedal via the control valve;
a man-machine interface connected to the electronic control unit; and
at least one sensor configured to detect at least one external signal of the mobile working machine,
wherein the brake function arrangement is designed to perform the electrohydraulic braking method according to claim 1.

6. The brake function arrangement according to claim 5, wherein the man-machine interface is designed as an external control device.

7. The brake function arrangement according to claim 5, wherein the at least one sensor is designed as a steering angle sensor configured to enable determination of the steering angle of the mobile working machine.

8. The brake function arrangement according to claim 5, wherein:
the hydraulic brake actuating pedal comprises one first and one second slider and one first and one second subassembly which are configured to be assembled together in a pre-assembled manner,
the first subassembly comprises the first slider and one first actuating piston which are both movable along a first axis,
at least one first spring is arranged between the first slider and the first actuating piston along the first axis,
the first subassembly comprises the second slider and one second actuating piston which are both movable along a second axis,
at least one second spring is arranged between the second slider and the second actuating piston along the second axis,
the first and second axes are parallel to each other,
the second subassembly comprises one third and one fourth actuating piston,
the third actuating piston is movable along the first axis,
the third actuation comprises a third contact surface configured to contact a first contact surface of the first actuating piston,
the fourth actuating piston is movable along the second axis, and
said fourth actuating piston comprises a fourth contact surface configured to contact a second contact surface of the second actuating piston.

9. The brake function arrangement according to claim 8, wherein the second subassembly of the hydraulic brake actuating pedal comprises a second body which accommodates one third and one fourth actuating piston, and the third actuating piston together with the second body delimits a first chamber, wherein the volume of the first chamber increases when the third actuating piston is moved in the direction of the first control piston, and wherein the fourth actuating piston together with the second body delimits a second chamber, wherein the volume of the second chamber increases when the fourth actuating piston is moved in the direction of the second control piston, and wherein the control valve is fluidically connected to the first and/or the second chamber.

10. The brake function arrangement according to claim 8, wherein hydraulic brake actuating pedals comprise a movable actuating element configured to actuate the first and second control pistons in parallel, wherein a third subassembly configured to be mounted to the second subassembly is provided in a pre-assembled manner, wherein the third subassembly comprises the actuating element, wherein the actuating element is configured to contact the third and fourth actuating pistons in parallel.

11. The electrohydraulic braking method according to claim 1, wherein the work machine is an agricultural machine.

12. The brake function arrangement according to claim 8, wherein the second subassembly of the hydraulic brake actuating pedal comprises a second body which accommodates one third and one fourth actuating piston, and the third actuating piston together with the second body delimits a first chamber, wherein the volume of the first chamber increases when the third actuating piston is moved in the direction of the first control piston, or wherein the fourth actuating piston together with the second body delimits a second chamber, wherein the volume of the second chamber increases when the fourth actuating piston is moved in the direction of the second control piston, and wherein the control valve is fluidically connected to the first and/or the second chamber.
